(19) United States
(12) Patent Application Publication
(10) Pub. No.: US 2025/0214460 A1
(43) Pub. Date: Jul. 3, 2025

(54) PLUG CONNECTOR PART

(71) Applicant: KIEKERT AKTIENGESELLSCHAFT, Heiligenhaus (DE)

(72) Inventor: Michael BERRES, Köln (DE)

(73) Assignee: KIEKERT AKTIENGESELLSCHAFT, Heiligenhaus (DE)

(21) Appl. No.: 18/852,732

(22) PCT Filed: Mar. 23, 2023
(86) PCT No.: PCT/DE2023/100226

§ 371 Date: Sep. 30, 2024

(30) Foreign Application Priority Data
Apr. 11, 2022 (DE) 10 2022 108 760.3

(51) Int. Cl. B60L 53/16; B60L 53/302; H01R 13/533

(52) U.S. Cl. CPC B60L 53/16; B60L 53/302; H01R 13/533; H01R 2201/26

(57) ABSTRACT

A plug connector part is provided for mechanically and electrically connecting to a mating plug connector part, in particular a motor vehicle-side charging socket for coupling to a charging plug as components of an electric charging infrastructure for electric or hybrid motor vehicles, or vice versa. The basic structure of the plug connector part has a housing and at least one electric contact element which is arranged in the housing. Additionally, a heat transfer element is provided which thermally contacts the electric contact element. According to the invention, at least one housing region which extends up to the contact element is designed as a heat transfer element.

The invention relates to a plug connector part for mechanically and electrically connecting to a mating plug connector part, in particular a motor vehicle-side charging socket for coupling to a charging plug as components of an electrical charging infrastructure for electric or hybrid motor vehicles, or vice versa, with a housing made of plastic and at least one electrical contact element arranged in the housing, and with a heat transfer element which is in thermal contact with the electric contact element.

The plug connector part is generally a charging socket in a motor vehicle that can be coupled with an associated charging plug-for example, on an electrical charging station. The charging plug (just like the charging socket) is part of an electrical charging infrastructure with the aid of which the rechargeable energy storage units or accumulators of electric or hybrid motor vehicles can be charged. In principle, the plug connector part on the motor vehicle can also be a charging plug instead of a charging socket. In this case, the charging station is equipped with an associated charging socket. As a rule, however, the electric or hybrid motor vehicle has a charging socket with several electrical contact elements, located in the housing, into which the charging plug connected to the charging station is inserted to charge the motor vehicle in question.

In order to be able to supply the high electrical performance of the electric motors in the motor vehicle in question with the necessary electrical energy on the one hand and to provide a sufficient range on the other, high-voltage batteries or accumulators are used nowadays, which are typically charged with high-voltage direct current. In addition to such DC (direct current) charging processes, most electric or hybrid motor vehicles also allow the charging process to be carried out via an alternating voltage in the sense of an AC (alternate current) charging process. At this point, however, low currents and long charging times are usually used, whereas, in the DC charging process described above, high voltages and high currents and the resulting short charging times are observed. In particular with DC charging processes, the fundamental problem is that the electrical contact elements used at this point become increasingly hot due to the high current intensity. This increases their resistance, which hinders the electrical charging process and the desired fast charging.

For this reason, the prior art according to EP 3 616 270 B1 describes a plug connector part including a temperature-monitoring device. If there is any overheating of the contact element, the temperature-monitoring device ensures that the power is switched off or at least reduced.

In the generic prior art according to EP 3 433 904 B1, the procedure is such that the contact element is equipped with a heat capacity element or a heat transfer element. This is intended to optimize and accelerate heat dissipation from the contact element to the environment. In the best case, this allows high currents to be transmitted without a possible and additionally provided temperature-monitoring device being activated. This has proven to be fundamentally successful.

However, the prior art according to EP 3 433 904 B1 overall provides for the heat capacity elements of different contact elements to be not only electrically insulated from each other, but to be mostly also connected to a shaft section of the contact element in a force-locking or positive-locking manner via an attachment piece. The heat capacity elements are moreover massive cuboidal bodies. As a result, the available installation space inside the plug connector part or charging socket is reduced and an overall increase in weight and costs is observed. This is no longer acceptable given the general requirements in the automotive sector for weight savings and cost optimization. This is where the invention steps in.

The invention is based on the technical problem of further developing such a plug connector part in such a way that a compact structure with cost advantages compared to the prior art is realized.

To solve this technical problem, a generic plug connector part within the scope of the invention is characterized in that at least one region of the housing which extends up to the contact element is designed as a heat transfer element.

The region in question which extends up to the contact element is usually designed so that it encloses the contact element. Moreover, the procedure in this context is such that the region in question, which forms the heat transfer element, has increased thermal conductivity compared to the rest of the housing. Special measures are required for this because the region in question, like the housing as a whole, is made of plastic, and any heat transfer therefore takes place rather slowly.

In this way, a compact embodiment is initially provided and implemented because the housing (made of plastic) for the plug connector part, which is required and obligatory anyway, or the charging socket typically implemented at this point also functions and is designed as a heat transfer element or heat capacity element, at least in the region which extends up to the contact element. This means that complex and bulky additional heat transfer elements can be expressly dispensed with. In this regard, the invention as a whole is based on the finding that the housing for the plug connector part is usually made of a thermoplastic. Here, a design as a plastic injection molded part has proven to be particularly convenient. Thermoplastics of this sort such as PP (polypropylene), PA (polyamide), PBT (polyethylene terephthalate), PE (polyethylene), etc. typically have thermal conductivities which, for polypropylene (PP), are for example 0.23 W/(m·K), or even up to 0.35 W/(m·K) for polyamides. Values of approximately 0.5 W/(m·K) are observed in connection with polyethylene.

According to the invention, the region of the housing functioning as a heat transfer element and extending up to the contact element can be made from a modified plastic in such a way that the employed plastic is one with embedded fillers to increase thermal conductivity. Suitable fillers in this context can be those that are electrically insulating and at the same time thermally conductive. They include, for example, aluminum compounds or boron compounds, particularly preferably aluminum oxide or boron nitride. This can yield increases in the thermal conductivity of the plastic in question by at least a factor of 3.

In this context, the relevant thermally conductive fillers in the plastic can

be provided in a grammage of up to 50 wt. % and more, so that overall thermal conductivities of significantly more than 1 W/(m·K) can be achieved. Further details on this and the appropriate fillers and plastics can be gathered from the relevant and pertinent prior art in this regard according to DE 10 2007 037 316 A1, which deals with thermally conductive and electrically insulating thermoplastic compounds, i.e., plastics with embedded fillers. In this context, additional reference is made to DE 10 2013 208 605 A1.

In addition to the option of equipping the region of the plastic housing in question, which is designed as a heat transfer element, with embedded fillers and thus with increased thermal conductivity, the invention provides, as a further alternative or additional option, that the region in question has at least one channel with a fluid located therein. The fluid is usually both thermally conductive and electrically insulating. Suitable fluids in this context are, for example, oils and in particular so-called transformer oils. In order to further improve thermal conductivity, the invention additionally proposes in this context for the channel in question to have at least one path outside the region and the housing accommodating it. This can further improve heat dissipation.

The region of the housing in question, which functions as a heat transfer element or heat capacity element, is typically a flange accommodating the contact element. The flange generally has a predominantly vertical plane extension compared to the contact element passing through the flange. This means that the longitudinal extension of the contact element and the extension of the plane forming the flange are predominantly arranged perpendicular to each other.

Moreover, in this context, the procedure can be such that the flange in question can be embedded in a front cover of the housing that surrounds it. The front cover of the housing, like the rest of the housing, can be made of the thermoplastic without embedded fillers. This means that the embedding of the filler is basically limited to that region or flange. Of course, it is also within the scope of the invention that the entire housing is made of the modified thermoplastic with the embedded fillers. For cost reasons, however, the embedding of the filler will be limited to the region functioning as a heat transfer element and extending up to the contact element, i.e., the flange of the housing.

As a result, a plug connector part for mechanically and electrically connecting to a mating plug connector part, in particular a motor vehicle-side charging socket is provided, which does not require any protruding attachments or fittings and is at the same time particularly cost-efficient in terms of production. On the one hand, this is ensured by the fact that the plastic with the embedded fillers, like the plastic for the rest of the housing, can be manufactured and processed by plastic injection molding. Moreover, the ingredients required in this regard, i.e., the fillers as well as the fluid used in the channel, are inexpensive so that in addition to a particularly compact design, a reduced manufacturing price viewed in comparison with the prior art is also achieved. These are the main advantages.

In the following, the invention is explained in more detail with the aid of a drawing showing only an exemplary embodiment; in the figures:

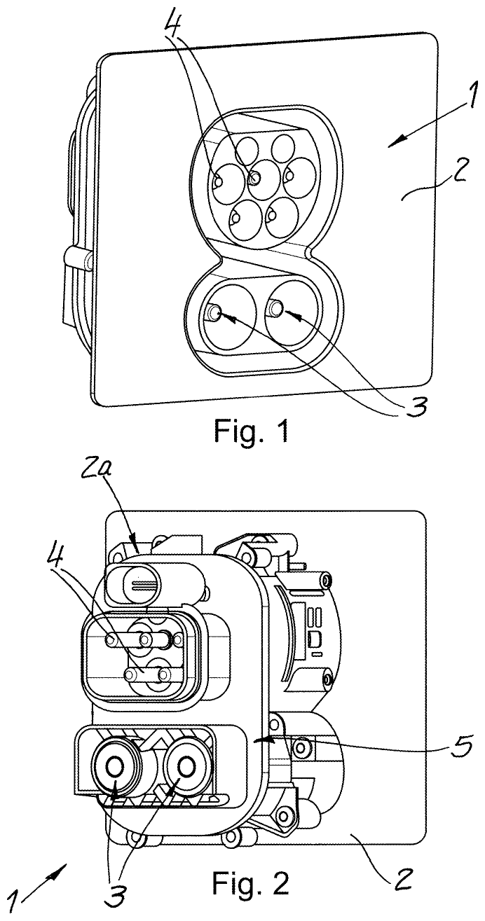

FIG. 1 is a front view of the plug connector part according to the invention in the form of a motor vehicle-side charging socket,

FIG. 2 is the associated rear view to FIG. 1,

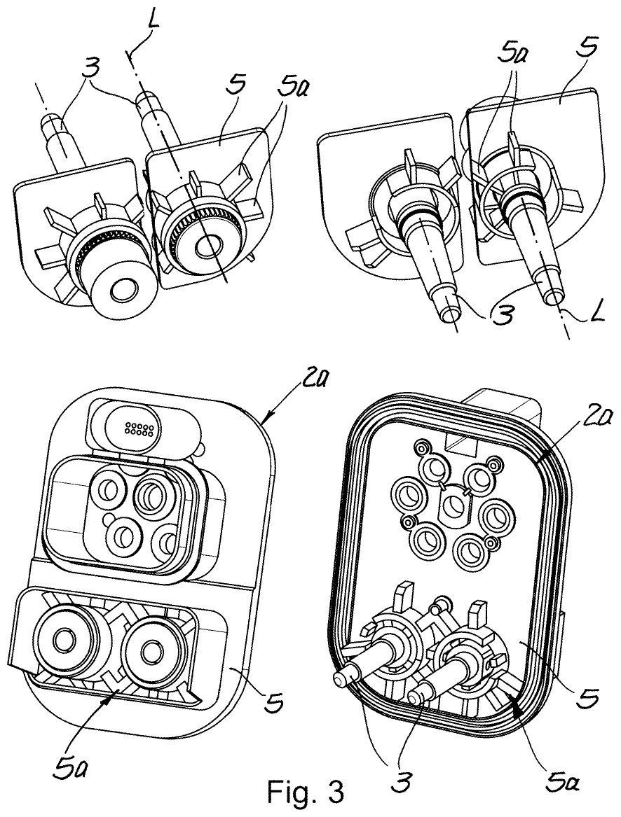

FIG. 3 are detail views of the subject matter according to in FIGS. 1 and 2, and

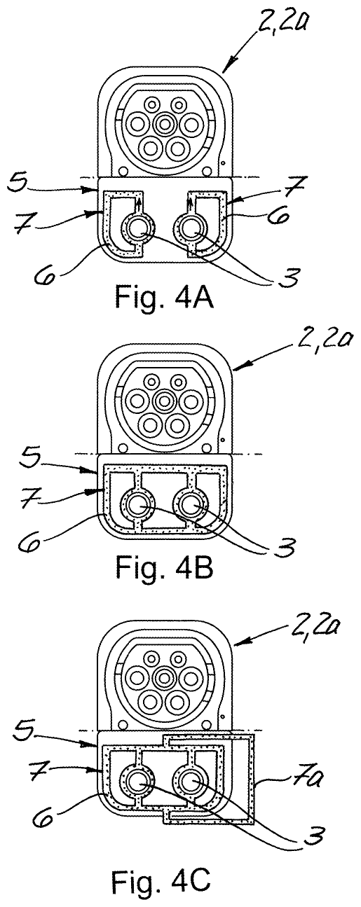

FIG. 4A-4C are another, modified embodiment.

The figures show a plug connector part for mechanical and electrical connection with a mating plug connector part. In fact, the plug connector part according to the exemplary embodiment in FIGS. 1 and 2 is a motor vehicle-side charging socket 1. The charging socket 1 is designed to be coupled to a charging plug, which is not shown in detail and is a component of an electrical charging infrastructure for electric or hybrid motor vehicles.

For this purpose, the charging socket 1 is equipped with a housing 2 made of plastic and at least one electrical contact element 3 located in the housing 2. In the following, only the two contact elements 3 required for a DC charging process are considered in more detail. The additionally provided further electrical contact elements 4 which, in contrast, are required for an AC charging process, will not be discussed in more detail. According to the exemplary embodiment, the two electrical contact elements 3 in the interior of the housing 2 are equipped with a heat transfer element 5, 6. The heat transfer element 5, 6 is in thermal contact with the electrical contact element 3.

For this purpose, at least one region 5 of the housing 2 extending up to the contact element 3 is designed as a heat transfer element 5. It can be seen that the region 5 in question or the heat transfer element 5 encloses the contact element 3, as illustrated in FIG. 3. For this purpose, the region 5 in question has increased thermal conductivity compared to the rest of the housing 2. The invention achieves this in that the region 5 in question is made of a plastic with embedded fillers to increase thermal conductivity.

In fact, the region 5, which is designed as a flange 5 receiving the contact element 3, is produced by injection molding from a thermoplastic such as PP, PE, etc. as well as embedded fillers in the form of, for example, aluminum oxide or boron nitride. This is done in such a way that the flange 5 in question has a predominantly vertical plane extension compared to a longitudinal extension L of the contact element 3. The contact element 3 is in fact a charging pin that is cylindrical in the exemplary embodiment. The flange 5 made of the plastic with embedded fillers is penetrated by the relevant contact element 3. For this purpose, the flange 5 according to the exemplary embodiment is additionally equipped with radial ribs 5a surrounding the contact element 3, which are connected to the flange 5. One can moreover see that the flange 5 in question is embedded in a surrounding front cover 2a of the housing 2, as clearly shown by the illustration in FIG. 3.

Within the context of a variant shown in FIG. 4A to 4C, the procedure is such that the heat transfer element 5, 6 is designed as a fluid 6. The fluid 6 in question is located in a channel 7 which is provided for that purpose in the region of the housing 2 designed as a heat transfer element 5 or flange 5. The fluid 6 in question in the interior the channel 7 can be one which is both thermally conductive and electrically insulating. Typically, oil and in particular transformer oil is used in this regard.

It can be seen in FIG. 4C that the channel 7 can also be equipped with a path 7a outside the region 5 in question or outside the flange 5, and therefore also outside the housing 2. In this way, a particularly effective heat dissipation via the path 7a outside the housing 2 of the charging socket 1 is provided and observed. As can be seen in FIG. 4A, a total of two different circuits and associated channels 7 can be realized for the two shown contact elements 3. FIG. 4B shows another possible guidance of the fluid 6 within the channel 7 or the multiple channels 7.

### LIST OF REFERENCE SIGNS

Charging socket 1
Housing 2
Contact element 3, 4
Heat transfer element 5, 6
Flange 5
Radial ribs 5a
Fluid 6
Channel 7
Path 7a
Contact element 8

1. A plug connector part for mechanically and electrically connecting to a mating plug connector part comprising:
a housing made of plastic and at least one electrical contact element located in the housing, and
a heat transfer element which thermally contacts the electrical contact element, the heat transfer element comprising at least one housing region of the housing extending up to the electrical contact element.

2. The plug connector part according to claim 1, wherein the housing region encloses the electrical contact element.

3. The plug connector part according to claim 1, wherein the housing region has increased thermal conductivity compared to portions of the housing outside of the housing region.

4. The plug connector part according to claim 1, wherein the housing region is made of a plastic with embedded fillers to increase thermal conductivity.

5. The plug connector part according to claim 1, wherein the housing region has at least one channel with a fluid located therein.

6. The plug connector part according to claim 5, wherein the channel has a path outside the housing region and outside the housing.

7. The plug connector part according to claim 5, wherein the fluid is configured to be thermally conductive and electrically insulating.

8. The plug connector part according to claim 1, wherein the housing region is designed as a flange receiving the electrical contact element.

9. The plug connector part according to claim 8, wherein the flange has a vertical plane extension relative to the electrical contact element passing through the flange.

10. The plug connector part according to claim 8, wherein the flange is embedded in a surrounding front cover of the housing.

11. The plug connector part according to claim 1, wherein the plug connector part is a motor vehicle-side charging socket for coupling to a charging plug as components of an electrical charging infrastructure for electric or hybrid motor vehicles.

12. The plug connector part according to claim 4, wherein the embedded fillers comprise a material that is electrically insulative and thermally conductive.

13. The plug connector part according to claim 7, wherein the fluid is an oil.

14. The plug connector part according to claim 8, wherein the housing region further includes a plurality of radial ribs that surround the electrical contact element and are connected to the flange.
